(19) United States
(12) Patent Application Publication
(10) Pub. No.: US 2020/0073996 A1
(43) Pub. Date: Mar. 5, 2020

(54) Methods and Systems for Domain-Specific Disambiguation of Acronyms or Homonyms

(71) Applicant: Stitched.IO Limited, Shrewsbury (GB)

(72) Inventors: Matt Wright, London (GB); Ian Harris, London (GB); Felix Terpstra, London (GB)

(21) Appl. No.: 16/115,358

(22) Filed: Aug. 28, 2018

(51) Int. Cl. G06F 17/30; G06F 15/18; G06F 17/27; G06K 9/62

(52) U.S. Cl. CPC G06F 17/30616; G06F 15/18; G06K 9/6256; G06F 17/3069; G06F 17/277

(57) ABSTRACT

A system for domain-specific disambiguation of terms, the system being implemented on one or more computers. The system comprises a plurality of machine-learned modules, wherein each machine-learned module comprises a selectively executable machine-learned classifier model corresponding to a respective one of a plurality of terms to be disambiguated, each term to be disambiguated being an acronym or homonym, and a fragment vectorizer module configured to: receive a body of text; identify one or more of said terms to be disambiguated within the received body of text; and generate context data for each of the identified terms. The system further comprises a feature generator configured to process the context data for each of the identified terms to obtain a feature vector for input into the respective machine-learned module for the identified term. Each of the machine-learned modules is configured to receive a respective feature vector and to generate one or more probabilities that the respective term to be disambiguated corresponds to one or more target outputs. The system further comprises a searchable document index builder configured to build a searchable document index based on the generated probabilities.

### FIELD

The present application relates generally to computing systems, machine-learning methods, and more particularly to methods and systems for domain-specific disambiguation of acronyms or homonyms.

### BACKGROUND

Natural language processing refers to the application of computer techniques to the processing of natural language and speech. Dealing with acronyms and homonyms is a difficult technical problem within natural language processing because such terms may have multiple meanings.

Take an example sentence; “I had a nice cup of java and then started to code up a solution to my computer science assignment, oddly enough, in java.” While a human can readily tell the difference between the word java that means coffee and the word java that means the computer programming language, a computer system can have a great deal of difficulty in understanding this distinction.

The problem is further exacerbated for acronyms. Take for example the acronym CDS. Possible meanings (retrieved from the internet) include:

Certificate of deposit

Counterfeit Deterrence System

Credit default swap

Comprehensive Display System

Canadian Depository for Securities

Centre de données astronomiques de Strasbourg

Centre for Development Studies

Commercial Data Systems

Conference of Drama Schools

Cooperative Development Services

Campaign for Democratic Socialism

Centre des démocrates sociaux

CDS—People's Party

Centro Democrático y Social

Convention démocratique et sociale-Rahama

Cadmium sulfide

Climate Data Store

Chromatography data system

Coding DNA sequence

Correlated double sampling

Chlorine Dioxide Solution

Compact Discs

CD single

Cockpit display system

Cross-domain solution

Cinema Digital Sound

Common Data Set

Community day school

Country Day School movement

Child-directed speech

Controlled Substances Act

Clinical decision support

### SUMMARY

Example embodiments of the present invention are directed to computer-implemented domain-specific disambiguation of acronyms or homonyms.

In one example implementation, a system for domain-specific disambiguation of terms is provided, the system being implemented on one or more computers. The system comprises a plurality of machine-learned modules, wherein each machine-learned module comprises a selectively executable machine-learned classifier model corresponding to a respective one of a plurality of terms to be disambiguated, each term to be disambiguated being an acronym or homonym. The system further comprises a fragment vectorizer module configured to: receive a body of text; identify one or more of said terms to be disambiguated within the received body of text; and generate context data for each of the identified terms. A feature generator is configured to process the context data for each of the identified terms to obtain a feature vector for input into the respective machine-learned module for the identified term. Each of the machine-learned modules is configured to receive a respective feature vector and to generate one or more probabilities that the respective term to be disambiguated corresponds to one or more target outputs. The system further comprises a searchable document index builder configured to build a searchable document index based on the generated probabilities.

In another example implementation, a computer-implemented machine-learning method is provided. The method comprises obtaining training data for each of a plurality of targets associated with a term to be disambiguated, wherein obtaining training data for each target comprises: performing one or more internet searches for information relating to one or more sources associated with the target; processing data derived from the results of the one or more internet searches using a fragment vectorizer module, wherein the fragment vectorizer module is configured to obtain context data for one or more instances in which the term to be disambiguated appears within the results of the one or more internet searches; generating a feature vector based on the context data, and labelling the feature vector based on the target. The method further comprises training a machine learning classifier model using the training data obtained for the plurality of targets, wherein the machine learning model is trained to generate one or more probabilities that the term to be disambiguated corresponds to each of the plurality of targets.

This specification also describes a computer-implemented method for domain-specific disambiguation of terms, comprising receiving a body of text at a fragment vectorizer module. The fragment vectorizer module is configured to identify a term to be disambiguated within the received body of text and generate context data relating to the identified term. The method further comprises selecting one of a plurality of machine learned classifier models, wherein the selected machine learned classifier model has been trained for disambiguating the identified term; generating a feature vector for input into the selected machine-learned classifier model, wherein the feature vector is generated based on the context data; receiving the feature vector at the selected machine-learned classifier model; and generating, using the machine-learned classifier model, one or more probabilities that the identified term corresponds to one or more target outputs.

### BRIEF DESCRIPTION OF THE DRAWINGS

So that the invention may be more easily understood, embodiments thereof will now be described with reference to the accompanying figures, in which:

FIG. 1 is a high level overview of a machine-learning system in accordance with an exemplary embodiment;

FIG. 2 illustrates components of machine learning system in accordance with an exemplary embodiment

FIG. 3 illustrates a computer-implemented training method according to an exemplary embodiment.

FIG. 4 illustrates a computer-implemented method for domain-specific disambiguation of terms in accordance with an exemplary embodiment.

### DETAILED DESCRIPTION

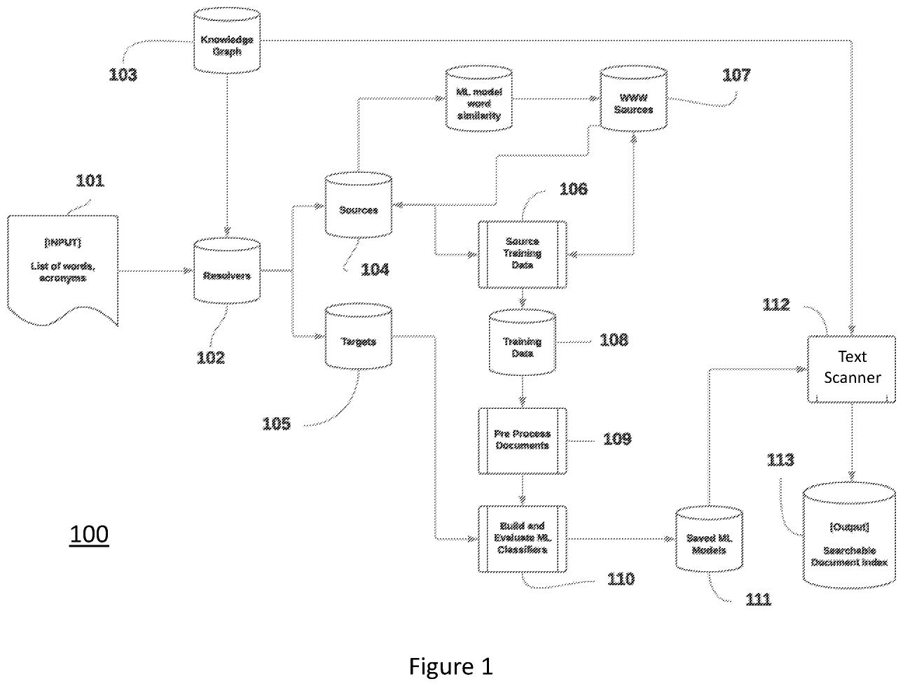

FIG. 1 is a high level overview of a machine-learning computing system 100 in accordance with an exemplary embodiment. As shown, a list of words, phrases and acronyms 101 may be fed into the system 100. Each term to be disambiguated is referred to in FIG. 1 as a “resolver’ 102. A resolver has certain associated properties, including its type, which may be an acronym or homonym.

Resolvers may be obtained from a knowledge graph 103, or from a domain taxonomy or other suitable source. The knowledge graph 103 may include a list of terms, referred to herein as “competencies”, which may be produced by a process including web scraping. Examples of competencies include “Business Analysis”, “C++”, “Hadoop”, “Java”, “Microsoft Exchange”. “Stock Exchange”. As well as core competencies the knowledge graph may also include aliases in order to group a set of words relating to a shared concept. Aliases may be obtained by webscraping and/or manual curation. For example, the following alises may be obtained for the term ‘Java’:

Java technology

Java source code

Java games

Java programming language

Java computer language

Java Programming Language language

Java for Windows

Java prog

Java programming

Javax

Java Programing Languge

Java language

Java code

Java Language Specification

The knowledge graph may be manually curated so that it only includes terms relevant to a particular business. For example a Hedge fund may want all the competencies in our initial example to be included (“Business Analysis”, “C++”, “Hadoop”, “Java”, “Microsoft Exchange”. “Stock Exchange”), whereas a consulting company may only want a smaller list (“Business Analysis”, “Stock Exchange”).

Some of the competencies are unambiguous, such as C++, but others are less clear. For instance when the word ‘exchange’ appears in a body of text, it is unclear which competency is being referred to, ‘Microsoft exchange’, ‘Stock Exchange’ or perhaps a competency which is not included in the knowledge graph at all.

The terms to be disambiguated (“resolvers”) may be determined with the knowledge graph, e.g. by way of manual curation. For instance, based on the knowledge graph, the term “exchange” may be identified as a resolver.

Related text data is then obtained for each resolver. This may be done by obtaining a number of expansions for each resolver, and then choosing a subset of said expansions for disambiguation. An expansion is a long form description that has a specific meaning, e.g. “Certificate of deposit” for CDS. An initial list of expansions may be obtained by web-crawling websites, such as dbpedia, or other public knowledge bases or sources from the world wide web (107). An example list of possible expansions for the acronym CDS that is obtained in this way might include:

Certificate of deposit

Counterfeit Deterrence System

Credit default swap

Comprehensive Display System

Canadian Depository for Securities

Centre de données astronomiques de Strasbourg

Centre for Development Studies

Commercial Data Systems

Conference of Drama Schools

Cooperative Development Services

Campaign for Democratic Socialism

Centre des démocrates sociaux

CDS—People's Party

Centro Democrático y Social

Convention démocratique et sociale-Rahama

Cadmium sulfide

Climate Data Store

Chromatography data system

Coding DNA sequence

Correlated double sampling

Chlorine Dioxide Solution

Compact Discs

CD single

Cockpit display system

Cross-domain solution

Cinema Digital Sound

Common Data Set

Community day school

Country Day School movement

Child-directed speech

Controlled Substances Act

Clinical decision support

A subset of the expansions is then selected based on the specific domain of interest. The domain of interest might for example be “information technology”, “financial services” etc. The domain-specific expansions may be selected using a machine learning algorithm, or may be human curated depending on requirements and domain knowledge. For example, to disambiguate the term CDS in the financial services domain we may wish to only consider the following expansions:

Certificate of deposit

Credit default swap

Canadian Depository for Securities

Cross-domain solution

Common Data Set

This subset of expansions is referred to herein as the “sources” of the resolver. More generally a resolver is associated with both sources 104 and targets 105. Sources 104 are metadata describing each expansion that is to be considered for the resolver, and may include information scraped from a knowledge source on the world wide web 107. Sources may include for example expansions (e.g. “Certificate of deposit”), as mentioned above, or other text summaries, or inward links from other entities in a taxonomy, or reference URLs, or HTML content etc. The purpose of this information is to obtain training data in a machine learning algorithm. It is stored for this purpose e.g. in a database or one or more text files (for example in json format).

Targets for a resolver may be defined as a subset of its sources. The purpose of a target is to define the number of end disambiguations we seek for the machine learning algorithm, which may be less than the number of sources. For example in the case of the acronym CDS we may wish to disambiguate based on the following sources and targets:

Sources:

1 Certificate of deposit

2 Credit default swap

3 Canadian Depository for Securities

4 Cross-domain solution

5 Common Data Set

Targets:

1 Certificate of deposit—1 source assignments (source 1)

2 Credit default swap—1 source assignments (source 2)

3 Canadian Depository for Securities—1 source assignments (source 3)

4 IT Architecture—2 source assignments (sources 4, 5)

Note that target 4 has two sources. We may wish to assign sources to targets on a per domain basis depending on the desired outcome. For example in the above case we may wish to know exactly the difference between banking instruments and regulatory authorities but be less concerned about disambiguations of CDS within information technology. Thus, “Cross-Domain Solution” and “Common Data Set” are brought together as target 4, “IT Architecture”.

To give another example, sources and targets may be determined for the resolver “Exchange” as follows:

| | | Competency to link to in |
|---|---|---|
| Source | Target | the Knowledge Graph. |
| Microsoft Exchange | Microsoft Exchange | Microsoft Exchange |
| Stock Exchange | Stock Exchange | Stock Exchange |
| Foreign Exchange | Stock Exchange | Stock Exchange |
| Commodities | Stock Exchange | Stock Exchange |
| Exchange | | |
| Telephone exchange | Telephone Exchange | None |

Note that some targets have been linked to the knowledge graph 103. If the word “exchange” is found in a text document and disambiguated (as discussed below) to a target corresponding to a competency listed in the knowledge graph 103 (such as “Microsoft Exchange”), a record may be stored that the text document includes a competency relating to “Microsoft Exchange”. On the other hand, if it is determined that “exchange” means “Telephone Exchange”, then no record is stored because “Telephone Exchange” is not included in the knowledge graph 103 and is therefore not considered relevant. More generally, in various implementations, targets are linked to competencies in the knowledge graph so that a determination can be made about whether a disambiguated term is relevant or not. This cuts down “false positives” when searching documents. The system ignores instances in which a document uses the term “Exchange” to mean “Telephone Exchange” which is not included in the knowledge graph 103. Moreover, the use of sources and targets allows control over how nuanced the disambiguation should be.

Once resolvers and corresponding targets and sources have been defined, training data is obtained (106) for training separate machine learning models for each resolver. This may be done by automatically carrying out internet searches for each of the sources for each resolver. Thus, in the case of the resolver “exchange”, automated searches may be carried out for “Microsoft Exchange”, “Stock Exchange”, “Foreign Exchange”, “Commodities Exchange” and “Telephone Exchange”. Text data derived from the searches is downloaded for use as training data 106.

The results of the searches for each source are used by the computing system 100 to generate training data 108 for machine learning classifier models 110 which are specific to each resolver. For example the results of the search for the source “Stock Exchange” may be used as training data for a machine learning classifier model for the resolver “exchange”, to teach that model in which context the term “exchange” means “Stock Exchange”.

Data derived from the results of the searches may be stored as text files or in a suitable information store. The stored data may be pre-processed 109. Pre-processing of text data using NLP techniques is known per se to those skilled in the art and will not be described in detail here. Briefly, pre-processing may include for example stopword removal, tokenization, lemmatization, ngram generation, punctuation removal, removing numbers and urls, breaking text into sentences, part of speech tagging and named entity detection. Such pre-processing advantageously removes noise from the eventual training data and may also tag certain parts of the text that may then be used as features in the machine learning model.

In various embodiments of the invention, a fragment vectorizer module may be used by the computing system 100 to extract context data from the pre-processed data. In particular, the fragment vectorizer module is configured to extract context data around a term that defines the context of that term.

The importance of context can be seen for example from the following passages of text relating to the term “exchange”.
“Find out how to prepare for certification on Microsoft Exchange. Get the Exchange Server training you need to grow your skills—and your career.”
“When exchange rates are volatile, companies rush to stem potential losses. What risks should they hedge—and how?”
“Consolidation among the world's major stock exchanges continued in 2011 with Deutsche Börse's announced acquisition of the New York Stock Exchange (NYSE). If that merger goes through, it will be part of a trend that ultimately benefits listed companies: it is simpler to manage the reporting requirements for one exchange than for two or three.”
“As economies across the world ride the ebb and flow of business cycles, fixed exchange rate regimes sometimes come under immense”
“Exchange rates are determined in the foreign exchange market, [2] which is open to a wide range of different types of buyers and sellers, and where currency trading is continuous: 24 hours a day except weekends, i.e. trading from 20:15 GMT on Sunday until 22:00 GMT Friday. The spot exchange rate refers to the current exchange rate. The forward exchange rate refers to an exchange rate that is quoted and traded today but for delivery and payment on a specific future date.”
“Trade involves the transfer of goods or services from one person or entity to another, often in exchange for money .”
“The emergence of exchange networks in the Pre-Columbian societies of and near to Mexico are known to have occurred within recent years before and after 1500 BCE”

The fragment vectorizer module extracts the “context” of words around a term to be disambiguated by selecting words (or other tokens) within a predefined window before and/or after the term. The fragment vectorizer module may be associated with the following parameters:
Overall window size (number of words to the left and/or right of the word to include)
Parts of speech and offsets.
   Combining the Spacy POS tagger (https://spacy.io/api/annotation#pos-tagging) with the position before or after the disambiguation term, Examples
   ‘<WPOS+11-NN>’ is the 11th word after the term, a Noun
   ‘<WPOS−1-VBD>’ is the 1st word before the term, a verb in the past tense.
Part of speech window (may be less than the overall window size)
Boundary markers: Optionally stopping at paragraph starts and ends
Ngrams: Number of ngrams to use
Maximum number of features
Max and Min document frequencies
Use of multiple sentences outside the single sentence a term appears in.

The inventors have found that the following configuration is highly effective:
Window size around +/−12
Using POS tagging +/−2
Using the −1 POS verb as a specific feature
Not letting windows expand beyond the start or end of the paragraph containing the word
Weighting the sentences +/−1 less than the sentence containing the term

Hence the fragment vectorizer module's responsibility is to take a body of text and decide, given a target word or phrase, how much of the text to include as the right context around a term. As noted above the fragment vectorizer module can be configured with the following properties:

window_size: this is how many words to consider either side of the term, this the primary controller of context.

pos_window_size: the number of Parts of Speech (POS)+/−to include examples

‘<WPOS+11-NN>’ is the 1st word after the term, a Noun

‘<WPOS−1-VBD>’ is the 1st word before the term, a verb in the past

For more detail on POS please see: https://spacy.io/api/annotation#pos-tagging

include_boundary_markers if the window size includes a piece of text that indicates a new paragraph should words before/after the paragraph break be included.

filter_stop_words: thie removes stop words like ‘a’, ‘the’, ‘and’ using known techniques.

multi_sent: if the window size includes a piece of text that indicates a new sentence should words before or after the sentence break be included.

Consider processing of the following example text by the fragment vectorizer module to determine context for the term “exchange”:

“

The clients were already there. There were two of them—Indonesians of Chinese extraction. They were part of infamous “bamboo” network of ethnic Chinese business interests that crisscrossed South East Asia. I was introduced. We exchange business cards. I took care to accept the proffered card with both my hands, my body slightly inclined at a respectful angle. We're here to trade.

Some background; The spot exchange rate refers to the current exchange rate. The forward rate refers to a exchange rate that is quoted and traded today but for delivery and payment on a specific future date.

Two people from a “Big 4” accounting firm were also there. It could have been the “Big 3” this week after a new round of mergers.

”

The properties of the fragment vectorizer module are set to:

FragmentVectorizer(window_size=5,
pos_window_size=2,
include_boundary_markers=True,
filter_stop_words=True,
multi_sent=True)

The context data output is shown below. Note that each output entry represents what the FragmentVectorizer outputs when it encounters the word ‘exchange’. There are therefore four entries, one for each time the word ‘exchange’ is mentioned in the text:

```
[
  [
    ‘crisscrossed’,
    ‘south’,
    ‘east’,
    ‘asia’,
    ‘introduced’,
    ‘business’,
    ‘cards’,
    ‘took’,
    ‘care’,
    ‘accept’,
    ‘<WPOS−1-VBD>’,
    ‘<WPOS−2-NNP>’,
    ‘<WPOS+1-NN>’,
    ‘<WPOS+2-NNS>’
  ],
  [
    ‘respectful’,
    ‘angle’,
    ‘trade’,
    ‘background’,
    ‘spot’,
    ‘rate’,
    ‘refers’,
    ‘current’,
    ‘exchange’,
    ‘rate’,
    ‘<WPOS−1-NN>’,
    ‘<WPOS−2-NN>’,
    ‘<WPOS+1-NN>’,
    ‘<WPOS+2-NNS>’
  ],
  [
    ‘spot’,
    ‘exchange’,
    ‘rate’,
    ‘refers’,
    ‘current’,
    ‘rate’,
    ‘forward’,
    ‘rate’,
    ‘refers’,
    ‘exchange’,
    ‘<WPOS−1-JJ>’,
    ‘<WPOS−2-NNS>’,
    ‘<WPOS+1-NN>’,
    ‘<WPOS+2-NN>’
  ],
  [
    ‘exchange’,
    ‘rate’,
    ‘forward’,
    ‘rate’,
    ‘refers’,
    ‘rate’,
    ‘quoted’,
    ‘traded’,
    ‘today’,
    ‘delivery’,
    ‘<WPOS−1-NNS>’,
    ‘<WPOS−2-NN>’,
    ‘<WPOS+1-NN>’,
    ‘<WPOS+2-VBN>’
  ]
]
```

In various embodiments, the computing system 100 includes a feature generator module configured to process context data generated by the fragment vectorizer module to obtain a vector of features for a respective machine learning model. For instance the feature generator may be configured to process the context data output obtained for the example text discussed above, to obtain a vector of features for a machine learning model for the resolver “exchange”.

In some implementations, the machine learning model may comprise a multiclass classifier such as a random forest classifier. Alternatively, a gradient boosting or GaussianNb model may be used. The model may be optimized for the precision metric (vs Recall or F1 Score). As will be understood by those skilled in the, the vector of features may comprise suitable features for input into the model that is used.

More specifically, feature selection for each model may be based on a subset of the context data obtained by the fragment vectorizer module. For example, if the fragment vectorizer module captures a large enough window size (e.g. 10) and a large enough POS window (e.g. 5), feature selection may be based on a reduced window size (to e.g. 5) and POS window size (to e.g. 2) without having to recalculate the POS tags for each fragment. Because the calculation of POS is expensive this approach leads to significant performance increase when a large number of text fragments are processed.

For example, feature selection may be based on
A bag of words representation, using the scikit-learn function “CountVectorizer”, e.g. CountVectorizer(ngram_range=(1,3),max_features=None,max_df=1.0,min_df1)
Window Size=5
POS Window Size=−2
Include boundary markers=True
Multi sentence weighing=True

However those skilled in the art will appreciate that various other features and values may be used, and feature selection may be optimized based on the dataset and through the use of an appropriate measurement metric. Once the correct feature set is defined this is saved with the model together with the model hyperparameters. Hence, each machine learned model may be set with different feature properties, e.g. different window sizes.

As another example, a list of features that helps predict if CDS is ‘Credit Default Swap’ or ‘Certificate of Deposit’ might include, but not be limited to:
The size of the window around the target word
The parts of speech preceding or trailing the target word
Use of a bag of words
Use of n-gram models
Ensemble models of all of the above

Training data for each machine learning model may be obtained using the techniques described above. As noted earlier, the results of searches for each source are used to generate the training data 108. More specifically, the results of a search based on a particular source (e.g. Foreign Exchange) may be processed in the fragment vectorizer module and the feature generator module to obtain one or more feature vectors. These feature vectors may be labelled with the target corresponding to the source on which the search was based (for the source “Foreign Exchange”, the target is “Stock Exchange”) to obtain training data for that target. Training data for other targets (e.g. Microsoft Exchange) may be obtained in the same way, and the training data for multiple targets may then be combined, thus obtaining training data for the machine learned model for the resolver “exchange”.

In block 110 the machine learning models are trained using the training data obtained for each model. More specifically, the training data stored for each resolver is used to train a supervised classification model for that resolver. As noted above, various models may be used, e.g. a multiclass classifier such as a random forest classifier, a gradient boosting or GaussianNb model. The model may be optimized based on a suitable metric, e.g. F score, where F=(2*Recall*Precision)/(Recall+Precision). Here, precision refers to the number of disambiguations accurately detected/total number of disambiguations detected. Recall refers to the number of disambiguations accurately detected/actual number of disambiguations. It will be understood that other metrics (e.g. macro vs microaveraging, receiver operating characteristic (ROC)) could be used.

As will be understood by those skilled in the art, the hyperparameters of each model may be tuned to optimize the metric. This may include modifying the choice of features to obtain the best results in accordance with the metric. Once trained, each trained machine-learned classifier model is saved to disk 111 for later retrieval.

During inference, the fragment vectorizer module and feature generator module may be used in combination with the trained machine-learned classifier models to disambiguate acronyms and homonyms that appear in text. As an example consider processing of the following sample texts for the acronym “CDS”:

Sample Text A:

“It may or may not be a big deal, this time round. But market participants have already been spooked by the possibility that Greece might be able to default without triggering its CDS at all. Now they can add to that another worry: that Greece might be able to default in such a manner as to leave the ultimate value of the instrument largely a matter of luck.”

The text may be processed by the fragment vectorizer module and feature generator module to obtain an appropriate vector of features for input into the trained machine learned module for the acronym CDS. In an example, the following output is produced when this vector of features is input into the model:

Sample Output A:

| Target | Predicted probability |
|---|---|
| Certificate of deposit | 0.01 |
| Credit default swap | 0.99 |
| Canadian Depository | 0 |
| for Securities | |
| IT Architecture | 0 |

Sample Text B:

“And that, in turn, reveals a significant weakness in the architecture of CDS documentation.”

Sample Output B:

| Target | Predicted probability |
|---|---|
| Certificate of deposit | 0.1 |
| Credit default swap | 0.3 |
| Canadian Depository | 0 |
| for Securities | |
| IT Architecture | 0.6 |

In various implementations, the system 100 may use the trained machine learned models to disambiguate terms included in a set of documents to be processed. When the system receives a new set of documents, the documents are processed to mine competencies. As noted above, “competencies” are a list of terms included in the knowledge graph 103. Some text phrases are mapped unambiguously in the knowledge graph to one competency (e.g. C++). However for some terms (e.g. “exchange”), a machine learned model is needed to disambiguate which competency is the correct one, or if a term corresponds to a competency at all.

The system 100 includes a text scanner 112 which takes two inputs, one is the list of unambiguous terms (plus aliases) from the knowledge graph, and the other is the list of terms to be disambiguated (i.e. the “resolvers”). The text scanner 112 is configured to scan the document. If the text scanner 112 finds something in the document that maps to the knowledge graph then this is included in a searchable index 113. If the text scanner 112 finds term in the text that corresponds to a resolver (i.e. if it finds a term on the list of terms to be disambiguated), then it uses the fragment vectorizer module, feature generator module, and the machine learned model for the resolver to obtain a probability prediction for each of the model's targets.

For example, for the text “when exchange rates are volatile, companies rush to stem potential losses. What risks should they hedge—and how?”, the following output may be produced:

| Target | Predicted probability |
|---|---|
| Microsoft Exchange | 0.01 |
| Stock Exchange | 0.99 |
| Telephone Exchange | 0 |
| Exchange of goods | 0 |

A threshold may be set for accepting a term as a competency, e.g. 85%. Since the probability for “Stock Exchange” exceeds the threshold the competency is included in the searchable index 113.

Consider another example in which the text “Trade involves the transfer of goods or services from one person or entity to another, often in exchange for money.” produces the following output:

| Target | Predicted probability |
|---|---|
| Microsoft Exchange | 0 |
| Stock Exchange | 0.4 |
| Telephone Exchange | 0 |
| Exchange of goods | 0.6 |

In this case the threshold is not met, i.e. the machine learned model is not sufficiently confident that the text can be disambiguated between targets. In this case neither competency is included in the searchable index.

In this way, the system reduces false positives. Ambiguous terms are only included in the searchable index is the system is sufficiently confident that the term belongs to a single competency included in the knowledge graph.

Hence, in some embodiments the overall output of the system is a searchable index which is built from a particular set of documents (e.g. a client's set of files). A client may be a medium to large organization with a digital workforce, such that the primary output of the workforce is in digital format. Examples include technology companies (code and knowledge articles), management consulting companies (pitch documents, proposals, cv documents and business specifications), or other organization in which the digital output of the employees represents the work that the workforce does as a whole.

The searchable index enables search and parsing of the client's documents, very often in conjunction with project schedules or timesheets (to add the dimension of time) in order to automatically and accurately ascertain what skills and competencies the workforce have been displaying through time when producing digital outputs. In order to understand what a workforce does via their digital documentation it is important to accurately understand the context of the words in those documents.

In addition to identifying the competencies that are included within each document, the searchable document index may include other information such as how many people worked on the document and how long the project that the document is part of ran for. For example:

| | Document 1 | Document 2 |
|---|---|---|
| Project Length | 1 month | 2 months |
| Number of people | 2 | 3 |
| exchange => Microsoft Exchange | 9 | 1 |
| exchange => Stock Exchange | 1 | 4 |
| exchange (ignored) | 5 | 0 |

A score may be calculated for how important each competency is in each document, based on the searchable document index. For example, the following equation may be used: (count/overall count)*months*people. Thus, for the competency “Microsoft Exchange”, the score for document 1 is (9/10)*1*2=1.8. For the competency “Stock Exchange” for document 2, the score is 4/5*2*3=4.8. More complex formula may be used to balance time, people and the correct disambiguation of the “exchange”. In some examples a term frequency-inverse document frequency (TFIDF) algorithm may be used.

More generally, the searchable document index provides a searchable index of every competency/project/document combination over time. It comprises a matrix which allows a company to examine what skills and competencies are being used in which projects and for how long, and can thus be used by companies to ensure that they put the right people on the right projects at the right time.

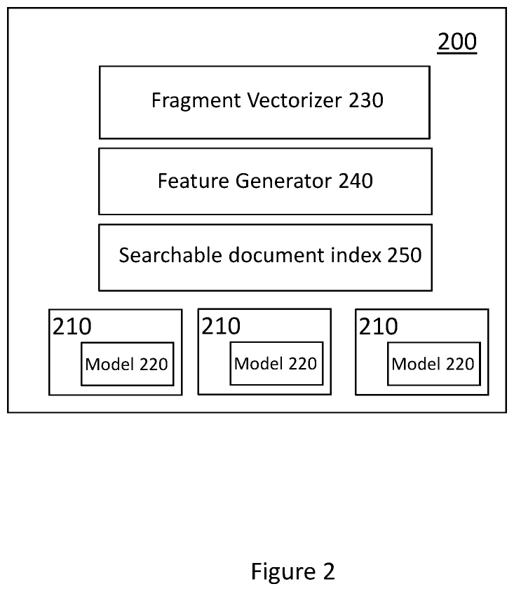

FIG. 2 illustrates components of a machine learning computing system 200 in accordance with an exemplary embodiment. As shown, the system includes a plurality of machine-learned modules 210, wherein each machine learned module 210 includes a machine-learned classifier model 220 such as a multi-class classifier. The system 200 includes a fragment vectorizer module 230 and a feature generator 240 configured to generate feature vectors for input into the respective machine-learned classifier models. The machine-learned modules are configured to receive a respective feature vector and to generate one or more probabilities that the respective term to be disambiguated corresponds to one or more target outputs. The system 200 also includes a searchable document index 250 which may be generated using the one or more probabilities as described above.

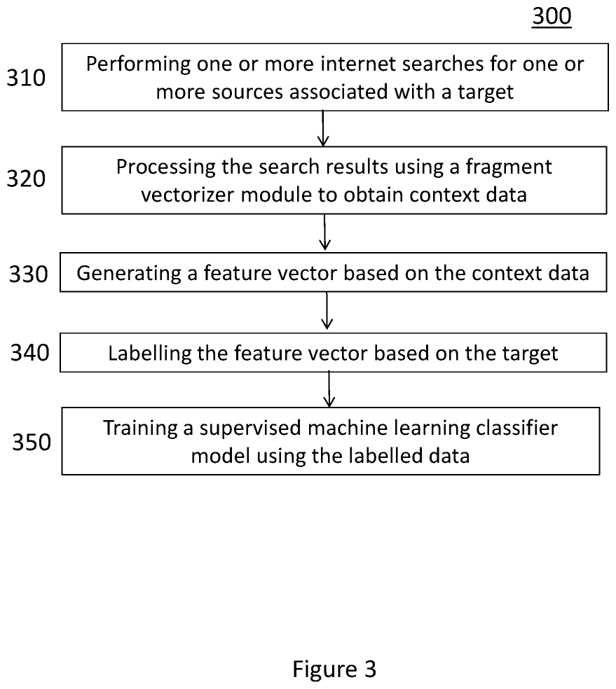

FIG. 3 illustrates a computer-implemented machine-learning method 300 in accordance with an exemplary embodiment. In the method, training data is obtained for each of a plurality of targets associated with a term to be disambiguated. Obtaining training data for each target comprises performing 310 one or more internet searches for information relating to one or more sources associated with the target, and processing 320 data derived from the results of the one or more internet searches using a fragment vectorizer module. The fragment vectorizer module is configured to obtain context data for one or more instances in which the term to be disambiguated appears within the results of the one or more internet searches. Obtaining the training data for each target further comprises generating 330 a feature vector based on the context data, and labelling 340 the feature vector based on the target. The method further comprises training 350 a machine learning classifier model using the training data obtained for the plurality of targets, wherein the machine learning model is trained to generate one or more probabilities that the term to be disambiguated corresponds to each of the plurality of targets.

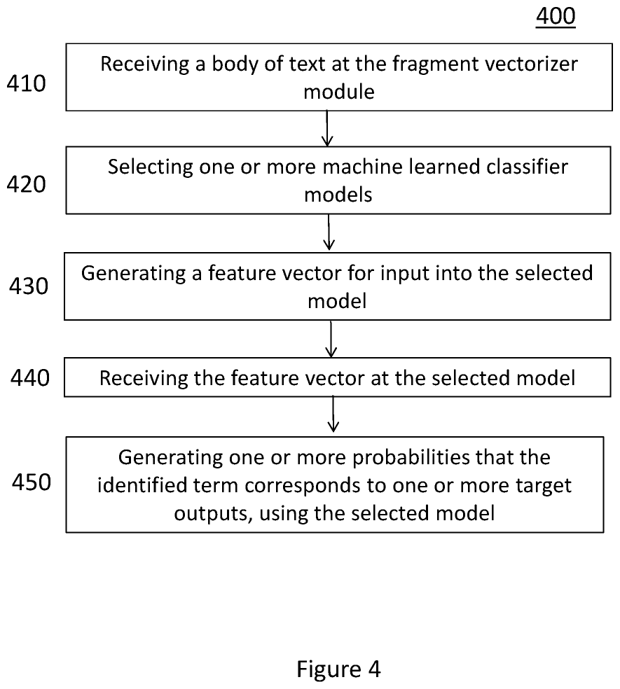

FIG. 4 illustrates a computer-implemented method 400 for domain-specific disambiguation of terms in accordance with an exemplary embodiment. The method comprises receiving 410 a body of text at a fragment vectorizer module. The fragment vectorizer module is configured to identify a term to be disambiguated within the received body of text, and to generate context data relating to the identified term. The method 400 further comprises selecting 420 one of a plurality of machine learned classifier models, wherein the selected machine learned classifier model has been trained for disambiguating the identified term. In step 430, a feature vector is generated for input into the selected machine-learned classifier model, wherein the feature vector is generated based on the context data. The feature vector is received 440 at the selected machine-learned classifier model and one or more probabilities that the identified term corresponds to one or more target outputs are generated 450 using the machine-learned classifier model.

In the above description, numerous details are set forth. It will be apparent, however, to one of ordinary skill in the art having the benefit of this disclosure that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulation of physical quantities. Usually, though not necessarily, these quantities take the form of electrical or magnetic signals capable of being stored, transferred, combined, compared and otherwise manipulated. It has been proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “identifying,” “classifying,” reclassifying,” “determining,” “adding,” “analyzing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purpose, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMS and magnetic-optical disks, read-only memories (ROMs), random access memories (RAMs), EPROMs, magnetic or optical cards, flash memory, or any type of media suitable for storing electronics instructions.

The words “example” or “exemplary” are used herein to mean serving as an example, instance, or illustration. Any aspect or design described herein as “example” or “exemplary” is not necessarily to be construed as preferred or advantageous over other aspects of designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” in intended to mean any of the natural inclusive permutations. That is, if X includes A; X includes B; or X includes both A and B, then “X includes A and B” is satisfied under any of the foregoing instances. In addition, the articles “a” and “an” as used in this specification and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein presented herein are inherently related to any particular computer or other apparatus. Various general purpose systems may be used with programs in accordance with the teachings herein, or it may prove convenient to construct a more specialized apparatus to perform required method steps. The required structure for a variety of these systems will appear from the description. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or method are not described in detail or are presented in simple block diagram format in order to avoid unnecessarily obscuring the present disclosure. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A system for domain-specific disambiguation of terms, the system being implemented on one or more computers, comprising:
a plurality of machine-learned modules, wherein each machine-learned module comprises a selectively executable machine-learned classifier model corresponding to a respective one of a plurality of terms to be disambiguated, each term to be disambiguated being an acronym or homonym;
a fragment vectorizer module configured to:
receive a body of text;
identify one or more of said terms to be disambiguated within the received body of text; and
generate context data for each of the identified terms; and
a feature generator configured to process the context data for each of the identified terms to obtain a feature vector for input into the respective machine-learned module for the identified term;
wherein each of the machine-learned modules is configured to receive a respective feature vector and to generate one or more probabilities that the respective term to be disambiguated corresponds to one or more target outputs, and
wherein the system further comprises a searchable document index builder configured to build a searchable document index based on the generated probabilities.

2. The system of claim 1, wherein the system further comprises a text scanner configured to receive one or more text documents and to identify a term to be disambiguated within the one or more text documents, wherein the text scanner uses the fragment vectorizer module, feature generator module, and the machine learned module for said term to be disambiguated to obtain a probability prediction for each of the target outputs.

3. The system of claim 2, wherein the term to be disambiguated that is identified within the one or more text documents is added to the searchable document index if the probability prediction for a target output exceeds a predefined threshold.

4. The system of claim 3, wherein the term to be disambiguated that is identified within the one or more document is added to the searchable document index if the target output that exceeds the predefined threshold is included in a knowledge graph.

5. The system according to claim 1, wherein the context data is defined by a window before and/or after the identified term in the received body of text.

6. The system according to claim 5, wherein the window size is between 6 and 18 words or tokens.

7. The system of claim 1, wherein the feature vector includes one or more features defined by a bag of words representation.

8. The system of claim 1, wherein at least one of said machine-learned classifier models includes one of a random forest classifier, a gradient boosting model, and a GaussianNb model.

10. A computer-implemented machine-learning method, comprising:
obtaining training data for each of a plurality of targets associated with a term to be disambiguated, wherein obtaining training data for each target comprises:
performing one or more internet searches for information relating to one or more sources associated with the target;
processing data derived from the results of the one or more internet searches using a fragment vectorizer module, wherein the fragment vectorizer module is configured to obtain context data for one or more instances in which the term to be disambiguated appears within the results of the one or more internet searches;
generating a feature vector based on the context data;
labelling the feature vector based on the target; and
training a machine learning classifier model using the training data obtained for the plurality of targets, wherein the machine learning model is trained to generate one or more probabilities that the term to be disambiguated corresponds to each of the plurality of targets.

11. The method of claim 10, comprising obtaining training data sets for each of a plurality of terms to be disambiguated, and training a plurality of machine learning classifier models based on the respective training data sets.

12. The method of claim 10, wherein the machine learning classifier models comprises one of a random forest classifier, a gradient boosting model, and a GaussianNb model.

13. The method of claim 10, wherein said one or more targets are a subset of said one or more sources.

14. The method of claim 10, wherein the feature vector includes one or more features defined by a bag of words representation.

15. A computer-implemented method for domain-specific disambiguation of terms, comprising:
receiving a body of text at a fragment vectorizer module, the fragment vectorizer module being configured to:
identify a term to be disambiguated within the received body of text; and
generate context data relating to the identified term;
selecting one of a plurality of machine learned classifier models, wherein the selected machine learned classifier model has been trained for disambiguating the identified term;
generating a feature vector for input into the selected machine-learned classifier model, wherein the feature vector is generated based on the context data;
receiving the feature vector at the selected machine-learned classifier model; and
generating, using the machine-learned classifier model, one or more probabilities that the identified term corresponds to one or more target outputs.

16. The method of claim 15, further comprising building a searchable document index based on the generated probabilities.

17. The method of claim 16, wherein the term to be disambiguated that is identified within the one or more text documents is added to the searchable document index if the probability prediction for a target output exceeds a predefined threshold.

18. The method of claim 17, wherein the term to be disambiguated that is identified within the one or more document is added to the searchable document index if the target output that exceeds the predefined threshold is included in a knowledge graph.

19. The method of claim 15, wherein the context data is defined by a window before and/or after the identified term in the received body of text.

20. The method of claim 15, wherein at least one of said machine-learned classifier models includes one of a random forest classifier, a gradient boosting model, and a GaussianNb model.
